(19) United States
(12) Patent Application Publication
(10) Pub. No.: US 2005/0270814 A1
(43) Pub. Date: Dec. 8, 2005

(54) Modified sinusoidal pulse width modulation for full digital power factor correction

(76) Inventor: In-Hwan Oh, Cupertino, CA (US)

Correspondence Address: SIDLEY AUSTIN BROWN & WOOD LLP, Suite 5000, 555 California Street, San Francisco, CA, 94104-1715, US

(21) Appl. No.: 10/858,701

(22) Filed: Jun. 2, 2004

(51) Int. Cl. H02M 1/00

(52) U.S. Cl. 363/98

(57) ABSTRACT

A converter-controller includes a feedback circuit, receiving a feedback voltage from an output stage and generating a current command signal according to the difference of a reference voltage and the feedback voltage. A duty cycle modulator generates a modified duty cycle utilizing the current command signal and a reference table. The controller further includes a counter producing a periodic signal, and a comparator, receiving the modified duty cycle and the periodic signal. The comparator generates a variable-duty-cycle output current corresponding to the difference of the periodic signal and the modified duty cycle.

### FIELD OF THE INVENTION

This invention relates in general to converter-controllers, and in particular to digital converter-controllers with an adjustable duty cycle.

### BACKGROUND OF THE INVENTION

The power factor control method has been utilized in various power supplies. Certain popular methods use an analog controller with a Discontinuous Conduction Mode (DCM) such as the FAN7527B and FAN4812 integrated circuits from Fairchild Semiconductor. Recently there has been a lot of research of possible digital approaches for controlling the power factor of converters. One requirement is that the control speed of the digital controllers should be suitable to deliver a performance comparable to analog controllers. Since Digital Signal Processors (DSPs) have fast calculation speed, they can be used as digital controllers. However, price considerations are detrimental to DSPs.

A simple digital PFC method is to fix the switching frequency and adjust the duty ratio to control the output voltage. This method is easily realized by using a low speed/price digital controller. However, an unwanted third harmonic component of about 8˜10% of the input signal typically appears in the output of these converters. It is difficult to eliminate this third harmonic component by using an EMI filter with a high cut-off frequency, since its frequency is close to the fundamental frequency. Furthermore, the third harmonic component in a full load condition is almost the same as in a light or no-load condition. Reducing or eliminating this third harmonic component is part of achieving low Total Harmonic Distortion (THD) in PFC controllers.

### SUMMARY

Briefly and generally, according to embodiments of the invention, a converter-controller includes a feedback circuit, receiving a feedback voltage from an output stage and generating a current command signal according to the difference of a reference voltage and the feedback voltage. The controller further includes a duty cycle modulator, coupled to the feedback circuit to receive the current command signal, and configured to generate a modified duty cycle utilizing the current command signal and a reference table. Further, the controller includes a counter, configured to produce a periodic signal and a comparator, coupled to the duty cycle modulator to receive the modified duty cycle and coupled to the counter to receive the periodic signal. The comparator is configured to generate a variable-duty-cycle output current corresponding to the difference of the periodic signal and the modified duty cycle.

Other embodiments of the invention consist of a method of controlling a converter. The method includes receiving a feedback voltage by a feedback circuit from an output stage, and generating a current command signal by the feedback circuit, corresponding to the difference of a reference voltage and the feedback voltage. Further, the method includes modulating a duty cycle by a duty cycle modulator according to the current command signal and a reference table, producing a periodic signal by a counter, and generating a variable-duty-cycle output signal by a comparator, corresponding to the difference of the modified duty cycle and the periodic signal.

### DESCRIPTION OF THE DRAWINGS

For a more complete understanding of the present invention and for further features and advantages, reference is now made to the following description taken in conjunction with the accompanying drawings.

FIG. 1 is a block diagram of a converter, according to an embodiment of the invention.

FIGS. 2A-C illustrates various implementations of converters according to embodiments of the invention.

FIG. 3 illustrates the voltage and line current of converters with fixed duty cycles.

FIG. 4 illustrates details of the signal shape of the line current in converters.

FIGS. 5A and B illustrate timing diagrams of converters and the third harmonic component with fixed duty cycles, respectively.

FIG. 6 illustrates the voltage and line current of converters with modified duty cycles according to embodiments of the invention.

FIG. 7 illustrates the modification of the duty cycle in more detail.

FIGS. 8A-C illustrate various signal profiles of embodiments of the invention.

FIGS. 9 A and B illustrate a summary timing diagram and the third harmonic component in embodiments of the invention, respectively.

### DETAILED DESCRIPTION

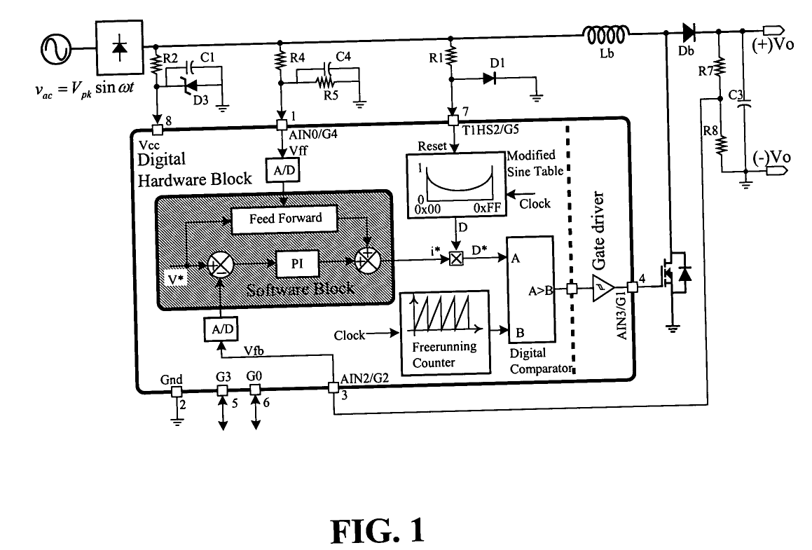

According to embodiments of the invention a converter-controller with an improved power factor conversion is described in relation to FIGS. 1-9.

FIG. 1 illustrates an embodiment of converter-controller 100, for controlling the operation of a converter 1. Converter-controller 100 includes a feedback circuit 110, which receives a feedback voltage Vfb from a resistor stepper 124 of output stage 120. Feedback circuit 110 generates a current command signal, which corresponds to the output of digital Proportional-Integral (PI) controller 119. The output of digital PI controller 119 is based on the difference of a reference voltage V* and the feedback voltage Vfb.

Converter-controller 100 controls the power factor conversion of converter 1 digitally. Accordingly, feedback circuit 110 receives feedback voltage Vfb through a analog-digital converter 113 from output stage 120.

One embodiment of convert-controller 100 is microcontroller FMS7401 from Fairchild Semiconductor. Microcontroller FMS7401 includes analog-digital converter 113 at pin(3:AIN2/G2). Therefore, in this embodiment, feedback voltage Vfb is coupled into pin(3:AIN2/G2).

Analog-digital converter 113 converts the feedback voltage Vfb to a digital feedback voltage Vdfb and couples Vdfb into feedback circuit 110. In some embodiments, feedback circuit 110 is referred to as a software block.

Converter-controller 100 further includes a feedback comparator 116, which receives reference voltage V* and digital feedback voltage Vdfb. Feedback comparator 116 generates a digital control signal, which corresponds to the difference of reference voltage V* and digital feedback voltage Vdfb.

The digital control signal of feedback comparator 116 is coupled into a digital proportional-integrator converter 119. Digital PI controller 119 generates an intermediate current command signal iᵢ*. One function of intermediate current command signal iᵢ* is to keep the output DC voltage at an approximately constant level even if the corresponding output current changes due to variations in the electric load.

In some embodiments, feedback circuit 110 also includes a feed-forward control block 118. Feed-forward control block 118 receives an input reference voltage Vᵢ*, which can be, for example, reference voltage V*. Feed-forward control block 118 also receives a digital feed-forward input signal Vdff corresponding to a DC input voltage filtered through R4, R5, and C4 to provide an averaged value through a feed-forward analog-digital converter 121. Feed-forward control block 118 generates a feed-forward signal i_{ff}, which corresponds to the output of feed-forward control block 118 to provide a fast output voltage compensation, when AC input voltage is changed.

In embodiments with feed-forward circuits, the signals of feed-forward circuit 118 and digital proportional-integrator 119 are unified in a synthesizer 126. Synthesizer 126 receives the intermediate current command signal iᵢ* and the feed-forward signal i_{ff}, and generates a current command signal i* by modifying intermediate current command signal iᵢ* according to feed-forward signal i_{ff}.

The generated current command signal i* is coupled from feedback circuit 110 into a duty cycle modulator 130. Duty cycle modulator 130 modulates current command signal i* according to a reference table. In some embodiments, the reference table is pre-programmed in a Read Only Memory (ROM). The modulation can be performed according to a periodic modulating signal. In some embodiment the periodic modulating signal in sinusoidal. The storing, or pre-programming, of the periodic modulating signal eliminates the need to sense the sinusoidal input voltage Vin. The modulation can be performed synchronously with an input voltage signal. The modulated current command signal translates to a modified duty cycle D*(k). The details of this modulation technique will be described in detail below.

Converter-controller 100 further includes a counter 140. Counter, which can be for example, a free-running counter, produces a periodic signal. In some embodiments the periodic signal is a saw-tooth signal.

Converter-controller 100 further includes a comparator 150. Comparator 150 is coupled to duty cycle modulator 130 and receives the modified duty cycle D*(k). Comparator 150 is also coupled to counter 140 and receives the periodic signal. One function of comparator 150 is to generate a variable-duty-cycle output signal, which corresponds to the difference of the periodic signal and modified duty cycle D*(k). When this difference is positive, the output of comparator 150 is “high” and when the difference is negative, the output is “low”. In various embodiments, comparator 150 operates digitally.

In some embodiments, comparator 150 outputs the variable-duty-cycle output signal to a gate driver 160. A function of gate driver 160 is to provide a gate-driving signal for a power device. The “high” output is such that it can make a corresponding power device conducting, whereas the “low” output can make the corresponding power device non-conducting.

In embodiments, where converter-controller 100 is microcontroller FMS7401 from Fairchild Semiconductor, gate driver 160 outputs the gate driving signal at pin(4:AIN3/G1). In some embodiments, the gate driver is FAN53418 from Fairchild Semiconductor.

Converter-controller 100 can be part of converter 1. Converter 1 includes a DC link 5. DC link 5 is energized by a rectified AC source 11.

DC link 5 is coupled to converter-controller 100 to provide an operating voltage Vcc at pin(8). The operating-voltage-coupling between DC link 5 and converter-controller 100 may include a resistor R2, coupled to a capacitor C1, and a Zener diode D3 in parallel to capacitor C1.

In embodiments including a feed-forward circuit 118, DC link 5 is coupled to feed-forward circuit 118 to provide a feed forward signal. The feed-forward-coupling of DC link 5 to feed-forward circuit 118 can include a resistor R4, coupled to a capacitor C4 and a resistor R5 in parallel to capacitor C4. Resistor R4 and capacitor C4 form a low pass filter to extract an average value of Vin. In embodiments, where converter-controller 100 is microcontroller FMS7401 from Fairchild Semiconductor, DC link 5 is coupled to feed-forward circuit 118 at pin(1:AIN0/G4).

DC link 5 is further coupled to duty cycle modulator 130 through a synchronization coupling to provide a synchronizing signal for the modulation of current command signal i* into modified duty cycle D*(k). The synchronization coupling can include a resistor R1 and a diode D1, coupled to the ground. These synchronization-coupling senses when Vin crosses zero and thus can be used to synchronize duty cycle modulator 130 with the input voltage signal by a reset operation. Such embodiments maintain their sinusoidal output voltage even if Vin is distorted by higher harmonics. In embodiments, where converter-controller 100 is microcontroller FMS7401 from Fairchild Semiconductor, DC link 5 is coupled to duty cycle modulator 130 at pin (7:T1HS2/G5).

Converter 1 further includes power device 170. Power device 170 can be a MOS-FET, a bipolar junction transistor, or an insulated gate bipolar transistor (IGBT). Power device 170 can be based on n-type conduction. In some embodiments, power device 170 is part of output stage 120. A function of power device 170 is to control the line AC input current to be an essentially sinusoidal waveform as well as to regulate the output voltage of output stage 120 even if the load current is changed.

In some embodiments with a boost topology, output stage 120 includes a boost inductor Lb, coupled to DC link 5 at a first terminal. The second terminal of boost inductor Lb is coupled to the anode of a boost diode Db, as well as to the drain of power device 170. The cathode of boost diode Db is coupled to a first output terminal (+)Vo. Output stage 120 further includes a capacitor C3, coupled between first output terminal (+)Vo and a second output terminal (−)Vo. In parallel to capacitor C3 is resistor stepper/bridge 124, including resistors R7 and R8. The midpoint of resistor stepper/bridge 124 is configured to generate feedback voltage Vfb by stepping down the output voltage Vo of output stage 120.

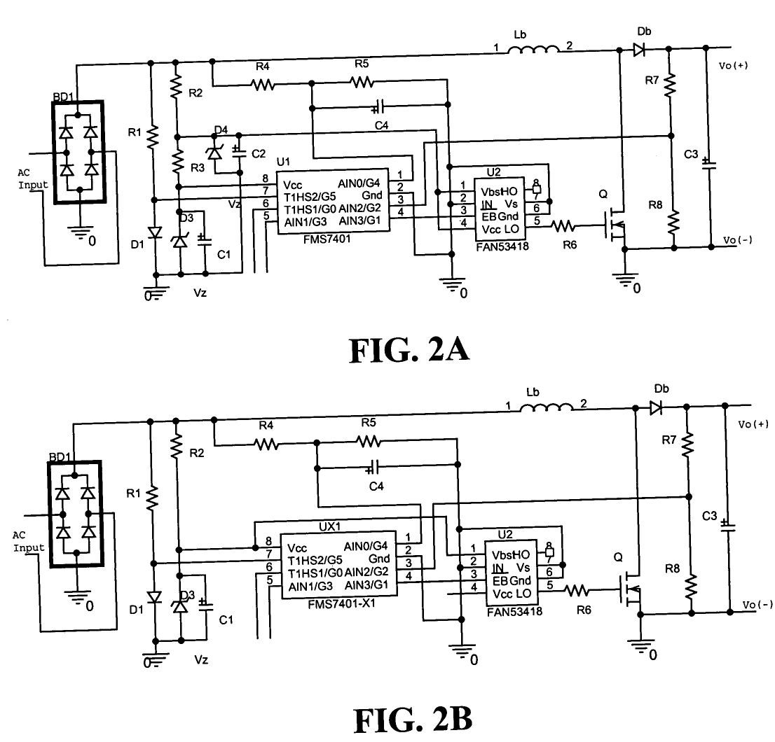

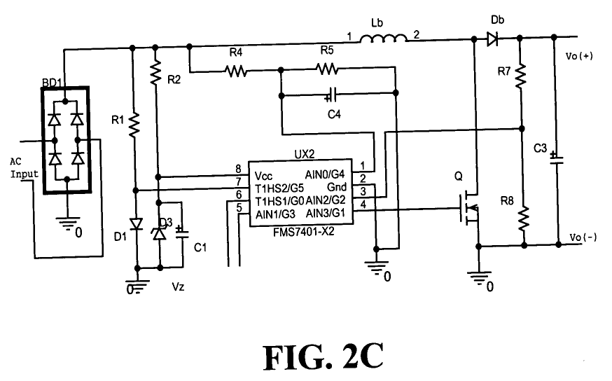

FIGS. 2A-C illustrate various modifications of the embodiment of FIG. 1.

FIG. 2A includes a self-standing gate driver U2. Pin(4) of converter-controller 100 outputs the variable duty-cycle output signal, but instead of directly driving the gate of power device 170, this signal is further controlled by gate driver U2. The operating voltage of gate driver U2 is provided by the additional circuit of resistor R3, capacitor C2, and Zener diode D4, in parallel to capacitor C2. Gate driver U2 can be, for example, Fairchild Semiconductor's integrated circuit FAN53418.

FIG. 2B illustrates another embodiment, where a voltage regulator is integrated in to converter-controller 100 so that the operating voltage for both converter-controller 100 and gate driver U2 are provided through the same operating-voltage-coupling, including the capacitor C1—resistor R2—diode D3 circuit.

FIG. 2C illustrates an embodiment, where the gate driver is integrated into converter-controller 100 as gate driver 160.

Next, the principles of the operation of converter-controller 100 will be described. As described above, one function of converter-controller 100 is to reduce higher harmonics, specifically third harmonics, in the input line current.

To begin, we will consider a harmonic AC input voltage:

$${v}_{ac} ( t ) = \sqrt{2} {V}_{rms} sin ω t , where ω = 2 π f = \frac{2 π}{T} . \qquad ( 1 )$$

The rectified DC rippled voltage is described as
v_{dc}=|v_{ac}(t)|=|\sqrt{2}Vᵣₘₛ sin ωt|. (2)

In embodiments of the invention, a digital control system is utilized, in which power device 170 is turned on and off depending on a load requirement. This control system is sometimes referred to as a Switched Mode Power Supply (SMPS) system.

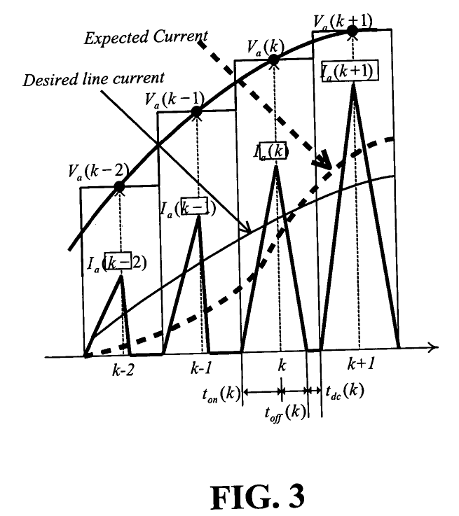

FIG. 3 illustrates that digital controllers generate sinusoidal currents by sampling the rectified voltage v_{dc} of Eq. (2), and converting it into a digitized signal. In some embodiments, the frequency of the input voltage or line voltage is about 50 Hz or 60 Hz, and this input voltage is sampled 10-10,000 times in a period. In general, in a pulse train with N pulses per half period, a sampling time tₛ is given by

$${t}_{s} = \frac{1}{2 f ( N + 1 )} , \qquad ( 3 )$$

where f is the above-introduced line frequency. The digitized DC voltage Vₐ(k) is generated by sampling the rectified voltage v_{dc} at the k^{th} sampling time

$${V}_{a} ( k ) = \vert {V}_{pk} \vert sin ( \frac{π k}{N + 1} ) . \qquad ( 4 )$$

The voltage drop v_{L}(k) across boost inductor L_{b} of output stage 120 is given by
v_{L}(k)=Vₒ−Vₐ(k), (5)
where Vo is the above-defined output DC voltage. The ratio of on-time tₒₙ, i.e. the time when the power device is on, and the total sampling time tₛ defines with the duty ratio D as

$$D = \frac{{t}_{on}}{{t}_{s}} ⇒ {t}_{on} = {t}_{s} D . \qquad ( 6 )$$

By using above relation, the off-time t_{off} at the k^{th} sampling time can be written as

$${i}_{L} ( k ) = \frac{{t}_{on}}{L} {v}_{L} ( k ) \to {t}_{off} ( k ) = L \frac{{i}_{L} ( k )}{{v}_{L} ( k )} = L \frac{{i}_{L} ( k )}{{V}_{a} - {V}_{a} ( k )} \qquad ( 7 )$$

FIG. 3 illustrates various aspects of the line current Iₐ(k,t) with a peak value labeled Iₐ(k), and the output current Iₒ(t), appearing at the AC input terminal. In existing converters, comparator 150 outputs a “high” or “low” signal according to whether the difference of a fixed duty cycle and the periodic signal is positive or negative. This output signal controls the gate of power device 170, resulting in a line current as shown. Within a sampling time tₛ, the line current Iₐ(k,t) rises for a period tₒₙ, while power device 170 is on. Line current Iₐ(k,t) decreases for a period of t_{off} while power device 170 is off. Finally, when the line current would cross zero, boost diode Db acquires a negative bias and the line current is kept essentially zero for a current discontinuity time t_{dc}. These three time intervals constitute the sampling time tₛ. Therefore
t_{dc}(k)=tₛ−tₒₙ−t_{off}(k), (8)

Since the voltage of an inductor is proportional to the time derivative of the current, to a good approximation the peak current Iₐ(k) in the k^{th} sampling period can be written as

$${I}_{a} ( k ) = \frac{{V}_{a} ( k )}{L} {t}_{on} . \qquad ( 9 )$$

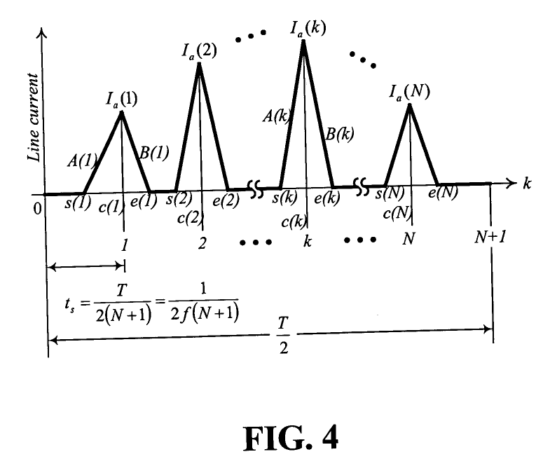

FIG. 4 illustrates that if the starting, center, and ending time instances of the k^{th} sampling time interval are denoted by s(k), c(k), and e(k), respectively, the rising and falling slopes A(k) and B(k) of line current Iₐ(k,t) are defined as

$$A ( k ) = \frac{{I}_{a} ( k )}{c ( k ) - s ( k )} and B ( k ) = \frac{{I}_{a} ( k )}{e ( k ) - c ( k )} . \qquad ( 10 )$$

The full line current Iₐ(t) (equal to the sum of line currents Iₐ(k,t) in the sampling periods indexed by k) in a Fourier decomposition can be represented with the help of the Fourier coefficients aₙ and bₙ as follows

$$\begin{matrix}{i}_{in} ( t ) = \frac{{a}_{0}}{2} + {\sum }_{n = 1}^{∞} {a}_{n} cos ( n ω t ) + {\sum }_{n = 1}^{∞} {b}_{n} sin ( n ω t ) , & ( 11 ) \\ {a}_{n} = \frac{2}{T} {\int }_{- T / 2}^{T / 2} f ( t ) cos ( \frac{2 π}{T} nt ) ⅆ t and \\ {b}_{n} = \frac{2}{T} {\int }_{- T / 2}^{T / 2} f ( t ) sin ( \frac{2 π}{T} nt ) ⅆ t . & ( 12 )\end{matrix}$$

a₀=0 because the line current has no dc component. The aₙ and bₙ Fourier coefficients in Eq. (12) can be determined by straightforward application of the slopes introduced in Eq. (10). In the k^{th} sampling period one obtains

$$\begin{matrix}{a}_{k , n} = \frac{2}{T} {\sum }_{k = 1}^{N} [ \begin{matrix}{\int }_{s ( k )}^{c ( k )} A ( k ) ( t - s ( k ) ) cos ( n ω t ) ⅆ t + \\ {\int }_{c ( k )}^{e ( k )} [ {I}_{a} ( k ) - B ( k ) ( t - c ( k ) ) ] cos ( n ω t ) ⅆ t - \\ {\int }_{s ( k ) + T / 2}^{c ( k ) + T / 2} A ( k ) ( t - s ( k ) - \frac{T}{2} ) cos ( n ω t ) ⅆ t + \\ {\int }_{c ( k ) + \frac{T}{2}}^{e ( k ) + \frac{T}{2}} ( - {I}_{a} ( k ) + B ( k ) ( t - c ( k ) - \frac{T}{2} ) ) cos ( n ω t ) ⅆ t\end{matrix} ] , & ( 13 ) \\ \begin{matrix} {b}_{k , n} = \frac{2}{T} {\sum }_{k = 1}^{N} [ \begin{matrix}{\int }_{s ( k )}^{c ( k )} A ( k ) ( t - s ( k ) ) sin ( n ω t ) ⅆ t + \\ {\int }_{c ( k )}^{e ( k )} [ {I}_{a} ( k ) - B ( k ) ( t - c ( k ) ) ] sin ( n ω t ) ⅆ t - \\ {\int }_{s ( k ) + T / 2}^{c ( k ) + T / 2} A ( k ) ( t - s ( k ) - \frac{T}{2} ) sin ( n ω t ) ⅆ t + \\ {\int }_{c ( k ) + \frac{T}{2}}^{e ( k ) + \frac{T}{2}} ( - {I}_{a} ( k ) + B ( k ) ( t - c ( k ) - \frac{T}{2} ) ) sin ( n ω t ) ⅆ t\end{matrix} ] . & \end{matrix} & ( 14 )\end{matrix}$$

The voltage drop across boost inductor L_{b} becomes high when the AC input voltage is low. Correspondingly, the inductor discharging time, t_{off}, becomes small. Conversely, the voltage drop across boost inductor L_{b} becomes low when the AC input voltage is high, making t_{off} low, as shown in FIG. 3.

The full line current, iᵢₙ(t) is coupled into a low-pass filter of the input stage. This input stage low pass filter extracts the fundamental Fourier components of iᵢₙ(t). It would be relatively difficult to eliminate the third harmonic component by using a low pass filter (or EMI), which can extract the fundamental frequency component and suppress all other higher frequency components from iᵢₙ(t). In contrast, embodiments of the present invention efficiently reduce the third harmonic component. Therefore, the fundamental frequency can be easily extracted from iᵢₙ(t) by using a conventional low priced EMI filter.

FIG. 3 illustrates that in existing designs the desired line current deviates from the realistically expected line current. In particular, the desired line current is higher than the expected line current when the discontinuity time t_{dc}(k) is sizeable compared to the sampling time tₛ. This happens when the AC signal has a low value, as discussed above. The low value of the realistically expected line current compared to the desired line current generates a sizeable third harmonic component, resulting in a distortion of the original pure harmonic waveform.

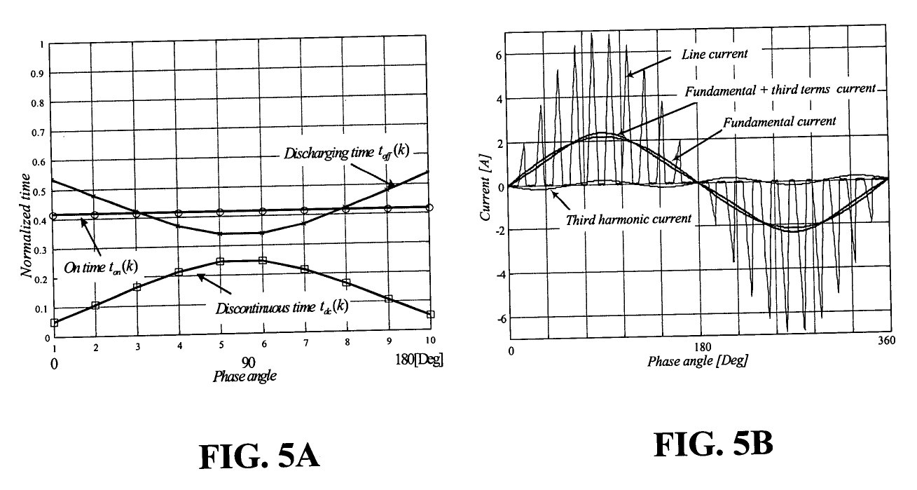

The operation of existing converters is summarized in FIGS. 5A-B.

FIG. 5A illustrates that in fixed duty cycle converters the on-time tₒₙ is constant throughout a cycle of the input voltage. The off-time t_{off}(k) and correspondingly the discontinuity time t_{dc}(k) still depend on the sampling index k, as the inductor's dynamics depend on the peak values Iₐ(k) of the line current.

FIG. 5B illustrates that in fixed duty cycle converters the line current has sizeable discontinuity times, generating a third harmonic distortion of the fundamental current.

Embodiments of the invention reduce this third harmonic component by modifying the duty cycle of converter 1, resulting in a reduction or elimination of the discontinuity time t_{dc}(k).

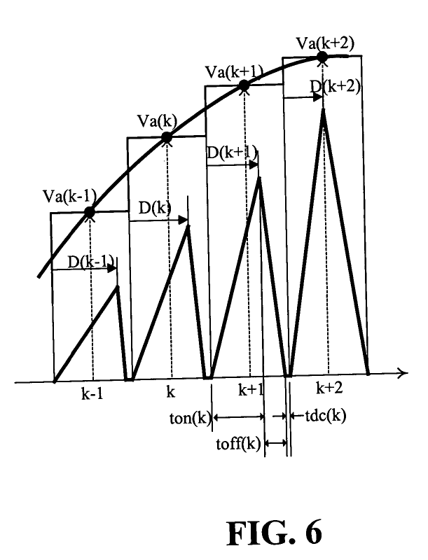

FIG. 6 shows the line current Iₐ(k,t) according to embodiments of the invention. In this embodiment the on-time tₒₙ(k) varies from sampling period to sampling period as shown. In other words, tₒₙ(k) is now dependent on the sampling index k. The length of on-time tₒₙ(k) is adjusted so that the discontinuity time t_{dc}(k) is reduced compared to fixed duty cycle converters, or, in some embodiments, essentially eliminated, as shown in FIG. 6.

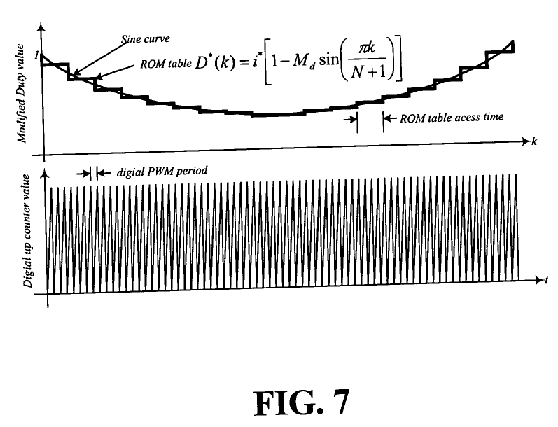

FIG. 7 illustrates the modification of the duty cycle. Duty cycle D*(k) is modified according to a periodic modulating signal during the period T of the input voltage. In some embodiments, in the k^{th} sampling period modified duty cycle D*(k) takes the value

$${D}^{*} ( k ) = {i}^{*} [ 1 - {M}_{d} sin ( \frac{π}{N + 1} k ) ] , \qquad ( 15 )$$

where M_{d} is a modified index and i* is the current command signal, as shown in the upper panel. Modified duty cycle D*(k) is coupled into digital comparator 150, where its value is compared to the periodic saw tooth signal of counter 140, shown in the lower panel.

Embodiments can use low speed controller circuitry by including a ROM and programming the periodic modulating signal into the ROM. The ROM access time is indicated as an update time by software and can be slower than the hardware digital pulse width modulator (PWM) signal period. In embodiments, where the frequency f of the input voltage is low, for example 50˜60[Hz], the ROM access time does not need to be fast. For a digital PWM with period of about 10˜15 microseconds, the ROM access time could be about few milliseconds.

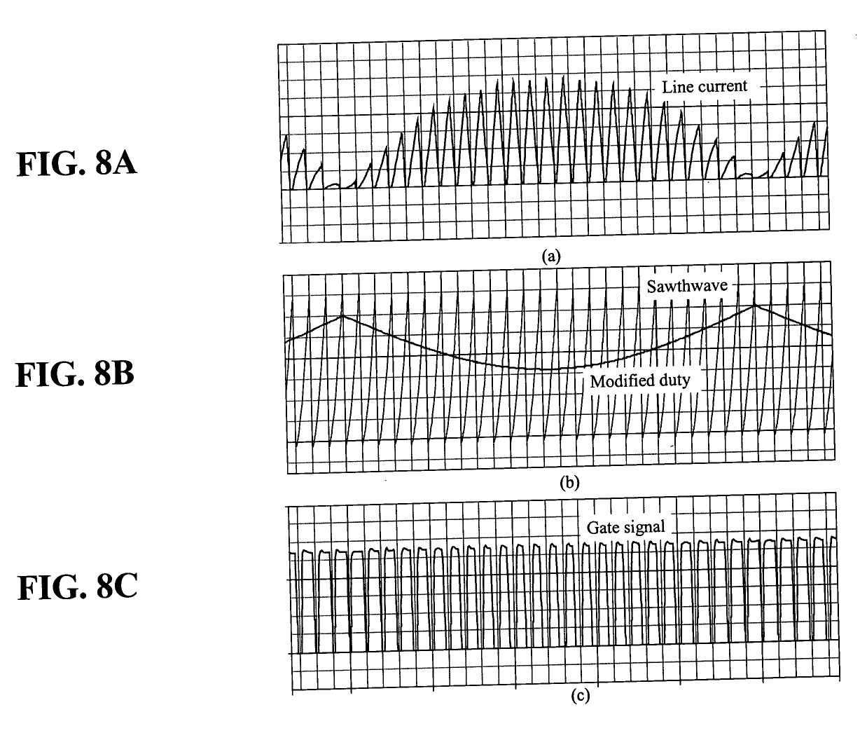

FIGS. 8A-C illustrate various timing diagrams of some embodiments.

FIG. 8B illustrates the modified duty cycle and the saw-tooth periodic signal overlaid, both coupled into comparator 150.

FIG. 8C illustrates the output signal of comparator 150. When modified duty cycle D*(k) is greater than periodic saw-tooth signal, then the output gate signal of comparator 150 is “high”. As described above, the output signal of comparator 150 serves as a gate signal for power device 170. As illustrated, the on-time tₒₙ of the gate signal varies from sampling period to sampling period within a period of the input voltage.

FIG. 8A illustrates the resulting line peak current Iₐ(k). In the illustrated embodiment, the discontinuity time t_{dc}(k) is essentially modified.

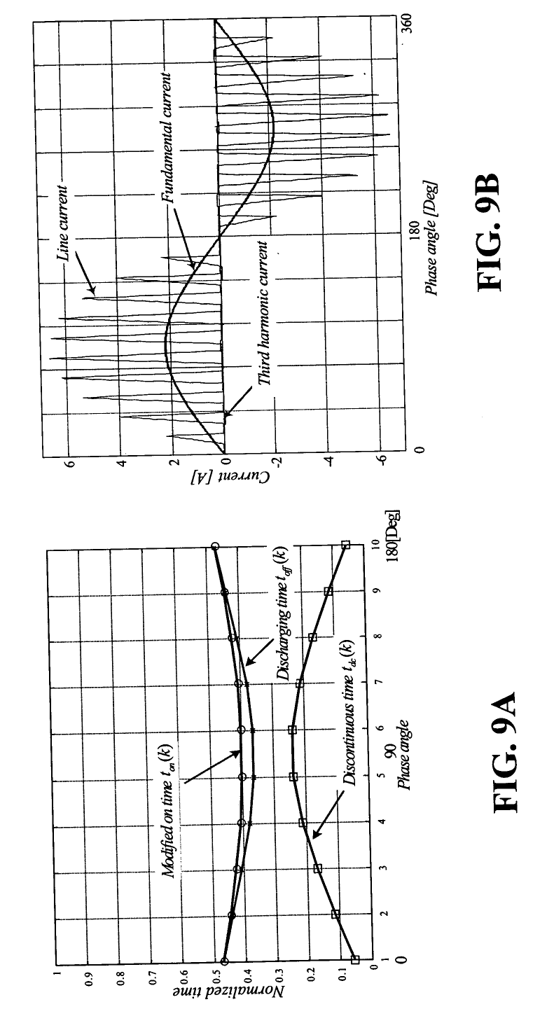

FIGS. 9A-B summarize the operation of some embodiments.

FIG. 9A shows that, in contrast to FIG. 5A, tₒₙ(k) depends on the sampling index k.

FIG. 9B shows an embodiment where the discontinuity time t_{dc}(k) has been modified. Correspondingly, the fundamental current is essentially indistinguishable from the current, which includes the generated third harmonic components. In particular, the line current value in the 0-30[Deg] interval is higher than in converters with fixed duty cycle, shown in FIG. 3 and FIG. 5B.

Since the described converter-controller utilizes digital control mechanism, in other embodiments, additional highly intelligent features can be implemented such as lowest standby power consumption, low total harmonic distortion, and high power factor correction from no-load to full load conditions.

Although the present invention and its advantages have been described in detail, it should be understood that various changes, substitutions, and alterations can be made therein without departing from the spirit and scope of the invention as defined by the appended claims. That is, the discussion included in this application is intended to serve as a basic description. It should be understood that the specific discussion might not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Neither the description nor the terminology is intended to limit the scope of the claims.

1. A converter-controller, comprising:
a feedback circuit, configured to receive a feedback voltage from an output stage and to generate a current command signal, corresponding to the difference of a reference voltage and the feedback voltage;
a duty cycle modulator, coupled to the feedback circuit to receive the current command signal, configured to generate a modified duty cycle utilizing the current command signal and a reference table;
a counter, configured to produce a periodic signal; and
a comparator, coupled to the duty cycle modulator to receive the modified duty cycle and coupled to the counter to receive the periodic signal, the comparator configured to generate a variable-duty-cycle output current corresponding to the difference of the periodic signal and the modified duty cycle.

2. The converter-controller of claim 1, wherein the converter-controller controls the power factor conversion digitally.

3. The converter-controller of claim 1, the converter-controller comprising:
a feedback analog-digital converter, configured to receive the feedback voltage from the output stage and to convert the feedback voltage to a digital feedback voltage.

4. The converter-controller of claim 3, the feedback circuit comprising:
a feedback comparator, configured to receive the reference voltage and the digital feedback voltage, and to generate a digital control signal, corresponding to the difference of the reference voltage and the digital feedback voltage.

5. The converter-controller of claim 4, the feedback circuit comprising:
a digital proportional-integrator converter, configured to receive the digital control signal of the feedback comparator and to generate an intermediate current command signal.

6. The converter-controller of claim 1, the feedback circuit further comprising:
a feed-forward circuit, configured to receive an input reference voltage and an input signal corresponding to an input voltage, and to generate a feed-forward signal, corresponding to the difference of the input reference voltage and the input signal.

7. The converter-controller of claim 6, the feedback circuit further comprising:
a synthesizer, configured to receive the intermediate current command signal and the feed-forward signal, and to generate the current command signal by modifying the intermediate current command signal according to the feed-forward signal.

8. The converter-controller of claim 7, wherein the duty cycle modulator is configured to receive the current command signal from the synthesizer.

9. The converter-controller of claim 8, wherein the variable-duty-cycle output current comprises a rising and falling current for a portion of a sampling period and a current discontinue time for another portion of the sampling period.

10. The converter-controller of claim 9, wherein the duty cycle modulator modulates the duty cycle to reduce the discontinuity time of the variable-duty-cycle output current, compared to a corresponding fixed-duty-cycle output current.

11. The converter-controller of claim 9, wherein the duty cycle modulator modulates the duty cycle signal to essentially eliminate the discontinuity time of the variable-duty-cycle output current.

12. The converter-controller of claim 1, wherein the duty cycle modulator modulates the duty cycle to reduce a third harmonic Fourier component of the variable-duty-cycle output current, compared to a corresponding fixed-duty-cycle output current.

13. The converter-controller of claim 12, wherein the duty cycle modulator modulates the duty cycle to reduce a total harmonic distortion of the variable-duty-cycle output current.

14. The converter-controller of claim 1, wherein the reference table is pre-programmed into a Read Only Memory.

15. The converter-controller of claim 14, wherein a periodic modulating signal is stored in the reference table.

16. The converter-controller of claim 15, wherein the periodic modulating signal is utilized to generate the modified duty cycle utilizing the current command signal i* and a reference table according to the formula:
$${D}^{*} ( k ) = {i}^{*} [ 1 - {M}_{d} sin ( \frac{π}{N + 1} k ) ] ,$$
k being the index of a sampling cycle within a period of an input voltage, N being the number of sampling cycles within the period of the input voltage, M_{d} being a modified index, and D*(k) being the modified duty cycle.

17. The converter-controller of claim 16, wherein the periodic signal of the counter is essentially a saw-tooth signal.

18. The converter-controller of claim 17, wherein the comparator is configured to receive the periodic signal of the counter and the modified duty cycle of the duty cycle modulator, and generate an output signal, corresponding to the difference of the periodic signal and the modified duty cycle.

19. The converter-controller of claim 18, wherein the output signal of the comparator is “high”, when the modified duty cycle is greater than the periodic signal, and the output signal is “low”, when the modified duty cycle is less than the periodic signal.

20. The converter-controller of claim 1, wherein the converter-controller is coupled to a DC link.

21. The converter-controller of claim 20, wherein the DC link is energized by one of a DC source and a rectified AC source.

22. The converter-controller of claim 20, wherein the DC link is coupled to the converter-controller to provide an operating voltage.

23. The converter-controller of claim 20, wherein the DC link is coupled to a feed-forward circuit in the feedback circuit, to provide a feed forward signal.

24. The converter-controller of claim 20, wherein the DC link is coupled to the duty cycle modulator to provide a synchronizing signal for the modified duty cycle.

25. The converter-controller of claim 20, further comprising:
a gate driver, coupled to the comparator to receive the variable-duty-cycle output signal, configured to control a gate of a power device.

26. The converter-controller of claim 25, wherein the power device is operable to control an output current of the output stage.

27. The converter-controller of claim 26, the output stage further comprising:
an inductor, wherein a first terminal of the inductor is coupled to the DC link;
a diode, wherein the anode of the diode is coupled to a second terminal of the inductor and the cathode of the diode is coupled to a first output terminal;
a capacitor, coupled between the first output terminal and a second output terminal; and
a resistor divider, coupled between the first and second output terminals, configured to generate the feedback voltage by stepping down an output voltage of the output stage.

28. The converter-controller of claim 27, wherein:
the power device is coupled to the second terminal of the inductor.

29. The converter-controller of claim 1, wherein the converter-controller senses a crossing point of two signals without fully sensing a line current.

30. The converter-controller of claim 1, wherein the operating speed of the converter-controller can be low compared to a conventional DSP based digital PFC controller.

31. A converter, including a converter-controller, which comprises:
a feedback circuit, configured to receive a feedback voltage from an output stage and to generate a current command signal, corresponding to the difference of a reference voltage and the feedback voltage;
a duty cycle modulator, coupled to the feedback circuit to receive the current command signal, configured to modify a duty cycle utilizing the current command signal and a reference table;
a counter, configured to produce a periodic signal; and
a comparator, coupled to the duty cycle modulator to receive the modified duty cycle and coupled to the counter to receive the periodic signal, the comparator configured to generate a variable-duty-cycle output signal, corresponding to the difference of the modified duty cycle and the periodic signal;
the converter further comprising:
a DC link to provide an operating voltage for the converter-controller, a feed forward signal for the feedback circuit, and a synchronizing signal for the duty cycle modulator; and
an output stage, including:
an inductor, wherein a first terminal of the inductor is coupled to the DC link;
a diode, wherein the anode of the diode is coupled to a second terminal of the inductor and the cathode of the diode is coupled to a first output terminal;
a capacitor, coupled between the first output terminal and a second output terminal;
a resistor divider, coupled between the first and second output terminals, configured to generate the feedback voltage corresponding to a stepped-down voltage of the output stage; and
a power device, controlled by receiving the variable-duty-cycle output signal at a gate, the power device being coupled to the second terminal of the inductor.

32. A method of controlling a converter, the method comprising:
receiving a feedback voltage by a feedback circuit from an output stage;
generating a current command signal by the feedback circuit, corresponding to the difference of a reference voltage and the feedback voltage without sensing a rectified input voltage and an inductor current;
modulating a duty cycle by a duty cycle modulator according to the current command signal and a reference table;
producing a periodic signal by a counter; and
generating a variable-duty-cycle output signal by a comparator, corresponding to the difference of the modified duty cycle and the periodic signal.

33. The method of claim 32, wherein generating a variable-duty-cycle output signal comprises:
outputting a “high” signal, when the modified duty cycle is greater than the periodic signal; and
outputting a “low” signal, when the modified duty cycle is less than the periodic signal.

34. The method of claim 32, the method further comprising:
modifying the duty cycle to reduce a current-discontinue-time of the variable-duty-cycle output current, compared to a corresponding fixed-duty-cycle output signal.

35. The method of claim 32, the method further comprising:
modifying the duty cycle to essentially eliminate a current-discontinue-time of the variable-duty-cycle output current.

36. The method of claim 32, the method further comprising:
modifying the duty cycle to reduce a third harmonic Fourier component of a current of the output stage, compared to a corresponding fixed-duty-cycle output current.

37. The method of claim 36, method further comprising:
modifying the duty cycle to reduce a total harmonic distortion of an output current of the output stage, compared to a corresponding fixed-duty-cycle output current.

38. The method of claim 32, the method further comprising:
pre-programming the reference table into a Read Only Memory.

39. The method of claim 38, the method further comprising:
storing a periodic modulating signal in the reference table.

40. The method of claim 39, the method further comprising:
utilizing the periodic modulating signal to modifying the duty cycle according to the formula:
$${D}^{*} ( k ) = {i}^{*} [ 1 - {M}_{d} sin ( \frac{π}{N + 1} k ) ] ,$$
k being the index of a sampling period within a period of an input voltage, N being the total number of sampling periods within the period of the output voltage, M_{d} being a modified index, and D*(k) being the modulated duty cycle.

41. The method of claim 32, the method further comprising:
controlling a power factor conversion digitally.
